(19) United States
(12) Patent Application Publication
(10) Pub. No.: US 2026/0262673 A1
(43) Pub. Date: Sep. 10, 2026

(54) SEAFOOD ANALOGUE COMPOSITION

(71) Applicant: AAK AB (publ), Malmö (SE)

(72) Inventors: Lucas HARDY, Malmö (SE); Carol KONG, Malmö (SE); Amelia (Wang Ning) CHOO, Malmö (SE)

(21) Appl. No.: 18/993,669

(22) PCT Filed: Jul. 17, 2023
(86) PCT No.: PCT/SE2023/050743

§ 371 Date: Jan. 13, 2025

(30) Foreign Application Priority Data
Jul. 15, 2022 (SE) 2230241-8

(51) Int. Cl. A23D 7/005; A23D 7/00; A23J 3/22

(52) U.S. Cl. CPC A23D 7/0053; A23D 7/003; A23J 3/227

(57) ABSTRACT

Disclosed herein is a seafood analogue composition comprising from 1% to 20% by weight of a fat composition; from 10% to 60% by weight of a stabilizer blend of one or more starches and one or more polysaccharides; less than 5% by weight of nonanimal protein; and from 30% to 70% by weight of water; wherein the fat composition comprises from 20% to 85% by weight of saturated fatty acid residues; from 10% to 50% by weight of stearic acid residues (C18:0); and from 2% to 35% by weight of lauric acid residues (C12:0); wherein said percentages of fatty acid residues refers to fatty acids bound as acyl groups in glycerides in the fat composition and being based on the total weight of C4 to C24 fatty acid residues bound as acyl groups present in the fat composition.

### FIELD OF THE INVENTION

The invention relates to seafood analogue compositions comprising a fat composition, a stabilizer blend of one or more starches and one or more polysaccharides and water, and the use of said seafood analogue compositions in food products. In particular, the invention relates to the use of certain fat compositions in seafood analogue compositions to improve various properties of said seafood analogue compositions.

### BACKGROUND OF THE INVENTION

There is an increasing demand for plant-based foods due to consumer's increasing desire to eat healthy, sustainably sourced food products and to generally lower their seafood intake. This has led to the development of seafood-analogues; seafood-free, vegetarian or vegan food products which mimic certain qualities of seafood or seafood-based products, such as the texture, taste and/or appearance.

Many different types of seafood analogues are available, such as those based on potatoes, lentils and beans, some of which aim to mimic seafood and seafood completely in terms of sizzling and browning during cooking, bleeding, colour, texture and taste.

Various fats have been proposed for use in seafood analogue compositions. It is important that the fat is not an animal-derived fat such that the seafood analogue compositions are suitable for consumption by vegetarians and vegans. Accordingly, animal fats that are typically solid at room temperature are generally not used in seafood analogue compositions. In order to produce a desirable seafood-analogue, it is important that the final product have an appealing taste, texture and mouthfeel, and have similar taste, texture and mouthfeel to seafood. Such properties might be affected by the nature of the fat included in the seafood analogue composition. The nature of the fat in seafood analogue compositions also typically has an effect upon juiciness of the compositions and upon flavour release as the fats often function as carriers for fat soluble flavours. The nature of the fat is also important for the processability of the seafood analogue dough such as during moulding of a seafood analogue composition.

Coconut oil, palm oil, sunflower oil and rapeseed oil are examples of vegetable derived fats that have been proposed for use in seafood analogue compositions. It is desirable that the fats mimic effects such as the taste, texture and mouthfeel of animal fats found in seafood. As a result, coconut oil and palm oil have attracted attention as they have easily accessible and available in high quantity compared to other vegetable oils. Of these oils, coconut oil is typically preferred due to the negative market perception concerning the production of palm oil, in particular negative environmental effects associated with the production of palm oil. Furthermore, palm oil contains a high amount of palmitic acid residues which is considered to be detrimental to cholesterol levels of consumers. A problem with both coconut oil and palm oil is that they are high in saturated fatty acids, which is generally considered unhealthy. The use of alternative oils lower in saturated fatty acid residues such as sunflower oil and rapeseed oil has been found to compromise desirable properties of seafood analogue compositions due to the liquid nature of the oils. Properties such as juiciness are compromised, and the liquid nature of the oils means that there is no structuring potential of the seafood analogue composition resulting in oily seafood doughs which create problems during moulding and processing of the seafood analogue compositions. As a result, coconut oil remains the industry standard for the fat used in seafood analogue compositions.

The inventors of the present invention have appreciated that there are various disadvantages of using coconut oil in seafood analogue compositions. Firstly, as discussed above, coconut oil is high in saturated fatty acid residues which is undesirable for consumers from a health perspective due to the association of saturated fatty acid residues in fats with heart disease, undesirable cholesterol levels, and related conditions. The inventors of the present invention have also appreciated that coconut oil, despite having a relatively high melting point for a vegetable oil, has a steep melting curve. In other words, at colder temperatures of less than 15° C., coconut oil is a hard brittle solid, whereas at higher temperatures of 30° C. to 35° C., the coconut oil is a liquid containing no or very little solid fat. It has been found by the inventors that the solid, hard brittle structure of coconut oil at lower temperatures means that the coconut oil is often difficult to process and sufficiently mix in with other components of the seafood analogue composition during manufacture, meaning that it is sometimes desirable for the coconut oil to be melted or heated beforehand. This is undesirable in manufacturing processes due to the extra energy required to melt and/or chop the coconut oil during manufacture. An additional disadvantage associated with the use of coconut oil is that its steep melting curve means that there is only a narrow temperature window in which coconut oil can be mixed into a seafood analogue composition as a solid. It has also been found that having no solid fat at 30° C. to 35° C. is undesirable since this results in an overly quick release of fat/flavour from the seafood analogue compositions. Many flavourings present in seafood analogue compositions are fat soluble and so are released overly quickly on melting of the fat. A further disadvantage of coconut oil may be that it often contains high levels of mineral oil saturated hydrocarbons (MOSH) and mineral oil aromatic hydrocarbons (MOAH).

It has been found by the inventors of the present invention that the use of certain fats in seafood compositions instead of coconut oil, rapeseed oil and other fats can address and/or alleviate many of the problems discussed above associated with the use of coconut oil and other fats in such compositions.

The documents discussed below discuss the utility of certain fat compositions in certain food products. However, the use of the fat compositions in seafood analogue compositions, and the possible advantages associated therewith over the state of the art are not contemplated.

WO2016/162529 discloses triglyceride compositions having reduced saturated fatty acid contents and higher amounts of unsaturated fatty acids. The compositions are taught for use as oils for deep fat frying of food products. The oils are taught as having a better nutritional profile than conventional oils used in deep fat frying, and to provide crispiness and a lower risk of oil seeping out from deep fat fried food products. The deep fat fried products produced using the oil are also reported as having a less waxy mouth feel.

Research has also shown that there are potential benefits to low-protein diets. By way of example, Wahl et al. (see Cell Reports 25, 2234-2243 Nov. 20, 2018) found that low-protein high-carbohydrate diets may provide a nutritional intervention to delay brain aging; Mirzaei et al. (see Current Opinion in Clinical Nutrition and Metabolic Care, 19(1):p 74-79, January 2016) found that lower protein consumption, specifically those derived from red meat and other types of animal sources, has many health benefits with respect to aging-related diseases and extending lifespan such as by reducing heart disease, diabetes and cancer; and Solon-Biet et al. (see Cell Reports 11, 1529-1534, Jun. 16, 2015).

However, it has also generally been found that the use of protein is essential in trying to replicate the texture of animal meat, such as seafoods. The proteins are believed to provide the desired functionalities such as gelation, emulsification, water holding and oil binding, which are seen as essential for seafood-analogue structure formation (see Kazir et al., Molecules 2021, 26(6), 1559)

There remains a need for providing a seafood analogue composition that solve or alleviate many of the problems discussed above such as to mimic the seafood fat present in seafood products.

In particular, it would be especially convenient to provide a seafood analogue composition having an improved flavour release and an improved texture when compared to conventional certain fats usually used in seafood analogue compositions including notably coconut oil or rapeseed oil. It is also desired to be able to produce a seafood analogue composition having reduced protein whilst maintaining the necessary properties to reproduce the texture of seafood meat and therefore desired organoleptic properties.

### SUMMARY OF THE INVENTION

According to a first aspect of the invention, there is provided a seafood analogue composition comprising from 1% to 20% by weight of a fat composition; from 10% to 60% by weight of a stabilizer blend of one or more starches and one or more polysaccharides; less than 5% by weight of non-animal protein; and from 30% to 70% by weight of water; wherein the fat composition comprises from 20% to 85% by weight of saturated fatty acid residues; from 10% to 50% by weight of stearic acid residues (C18:0); and from 2% to 35% by weight of lauric acid residues (C12:0); wherein said percentages of fatty acid residues refers to fatty acids bound as acyl groups in glycerides in the fat composition and being based on the total weight of C4 to C24 fatty acid residues bound as acyl groups present in the fat composition.

The present invention is based upon the surprising finding that certain fat compositions solve or alleviate many of the problems discussed above associated with the use of coconut oil and other fats in seafood analogue compositions. It has been found that the certain fat compositions have an improved nutritional profile relative to coconut oil due to having lower amounts of saturated fatty acid residues. Surprisingly, the inclusion of these fat compositions in seafood analogue compositions in place of coconut oil has been found to not negatively affect, and in some cases improve various properties of seafood analogue compositions such as various sensory properties of the compositions. It is believed that these certain fat compositions with improved nutritional profile provide improved juiciness to the seafood analogue compositions when cooked or partially cooked, in comparisons to seafood analogue compositions comprising an equivalent amount of coconut oil or liquid oils as sunflower oil or rapeseed oil. It is also believe that the use of the certain fat compositions in place of coconut oil also has a positive effect on the taste of the seafood analogue composition once cooked. In particular, it has been found that the fat compositions provide an optimized flavour release when compared to compositions containing rapeseed oil. Without being limited by theory, this is believed to be due to the fat compositions containing higher amounts of solid fat at mouth temperatures of 30° C. to 35° C. A further advantage of the certain fat compositions compared to coconut oil may be that they can be crystallised in a more ‘plasticised form’ meaning that said compositions are more ‘deformable’ than coconut oil at typical processing temperatures meaning that said fat compositions can be incorporated and mixed into seafood analogue compositions more easily. Easier processability and manufacture is thus provided. Alternatively, plasticised fat structures of crystallised fat can be provided and mixed with other components of a seafood analogue composition. A further advantage of the compositions for use in the invention is that the stabilizer blend of one or more starches and one or more polysaccharides gives an optimized texture to the seafood composition. Thus, the fat compositions thus improve both the nutritional value and sensory properties of the finished seafood analogue composition product.

Preferably, the fat composition comprises from 20% to 70% by weight of saturated fatty acids, and more preferably from 20% to 60% by weight of saturated fatty acids. In some embodiments, the fat composition comprises 65% to 85% by weight of saturated fatty acids. In other embodiments, the fat composition comprises from 20% to 65% by weight of saturated fatty acids. The amount of saturated fatty acid residues present in the fat composition may be tailored so as to provide the specific desired properties of the fat composition. For example, where the fat composition comprises a higher saturated fat content of from 65% to 85% by weight, the fat composition may be particularly useful for providing hard, brittle solid structures of fat that can be easily admixed with other components of the seafood analogue composition. In other embodiments, the fat compositions comprise from 20% to 65% by weight of saturated fatty acids. Said fat compositions have been found useful in providing the plasticized fat structure effect described above.

Typically, the fat composition comprises from 2 to 12% by weight of St2M triglycerides, preferably from 5 to 12% by weight of St2M triglycerides. A St2M triglyceride is a triglyceride molecule comprising two stearic acid residues and one residue of either lauric acid or myristic acid. Without being limited by theory, it has been found that fat compositions comprising St2M triglycerides in the amounts specified above aids in providing both the plasticized fat structure effect. The St2M triglycerides crystallise fast and bind oil well which aids in the provision of the effects discussed above.

Typically, the fat composition comprises from 5 to 35 percent by weight of CN46 and CN48 triglycerides, preferably from 10 to 30 percent by weight of CN46 and CN48 triglycerides. The abbreviation CN stands for the total carbon number of the fatty acid moieties present in the triglyceride molecule. For example, a triglyceride comprising two stearic acid residues and one lauric acid residue would have a total carbon number of 48.

Preferably, the fat composition comprises less than 10% by weight of palm oil, more preferably less than 5% by weight of palm oil, and still more preferably less than 2% by weight of palm oil. Most preferably the composition does not comprise palm oil.

The fat composition preferably is a non-hydrogenated fat composition.

The fat composition preferably comprises a greater amount of stearic acid than palmitic acid. This is advantageous from a nutritional perspective since stearic acid has a neutral effect upon total cholesterol and LDL cholesterol levels, whereas palmitic acid is known to increase total cholesterol and LDL cholesterol levels. Typically, the fat composition comprises 20% by weight or less, and preferably 10% by weight or less of palmitic acid (C16:0). Typically, the fat composition has a weight ratio of stearic acid (C18:0) to palmitic acid (C16:0) of from 1:1 to 12:1. Typically, the fat composition has a weight ratio of lauric acid (C12:0) to stearic acid (C18:0) of from 1:4 to 4:1. Preferably, the fat composition comprises from 10% to 25% by weight lauric acid (C12:0); and/or from 15% to 45% by weight stearic acid (C18:0). More preferably, the fat composition comprises from 10% to 25% by weight lauric acid (C12:0); and from 15% to 45% by weight stearic acid (C18:0).

Typically, the fat composition has one or more of the following properties.
(i) the fat composition has a solid fat content (SFC) N40 of less than 10, measured on unstabilised fat according to ISO 8292-1, preferably from 1 to 9, and more preferably from 2 to 8;
(ii) the fat composition has a solid fat content (SFC) N20 of from 35 to 60, preferably from 25 to 56, more preferably from 20 to 40, as measured on the unstabilised fat according to ISO 8292-1; and
(iii) the fat composition has a solid fat content (SFC) N30 of from 5 to 35, preferably from 8 to 32; more preferably from 8 to 30, as measured on the unstabilised fat according to ISO 8292-1.

Preferably, the fat composition has all three of the above properties.

The term “fat” as used herein refers to glyceride fats and oils containing fatty acid acyl groups and does not imply any particular melting point. The term “oil” is used synonymously with “fat” herein.

The term “fatty acid”, as used herein, refers to straight chain saturated or unsaturated (including mono- and poly unsaturated) carboxylic acids having 8 to 24 carbon atoms. A fatty acid having x carbon atoms and y double bonds may be denoted Cx:y. For example, palmitic acid may denoted C16:0, oleic acid may denoted C18:1. Percentages of fatty acids in compositions referred to herein include acyl groups in tri-, di- and mono-glycerides present in the glycerides and are based on the total weight of C8 to C24 fatty acids. The fatty acid profile (i.e. composition) may be determined, for example, by fatty acid methyl ester analysis (FAME) using gas chromatography according to ISO 12966-2 and ISO 12966.4.

Triglyceride content may be determined for example based on molecular weight differences (Carbon Number (CN)) by AOCS Ce 5-86. The notation triglyceride CNxx denotes triglycerides having xx carbon atoms in the fatty acyl groups, e.g. CN54 includes tristearin. Amounts of triglycerides specified with each carbon number (CN) as is customary terminology in the art are percentages by weight based on total triglycerides of CN26 to CN62 present in the fat composition.

As used herein, “%” or “percentage” relates to weight percentage i.e. wt. % or wt.-% if nothing else is indicated.

The fat composition may be made from naturally occurring or synthetic fats, fractions of naturally occurring or synthetic fats, or mixtures thereof, that satisfy the requirements for fatty acids and triglyceride compositions discussed above. Preferably, the fat composition is derived from a blend of naturally occurring fats.

Preferably, the fat composition comprises an interesterified fat, and more preferably wherein the fat composition comprises an interesterified fat blend. The interesterified fat or interesterified fat blend may be produced by chemical interesterification, enzymatic interesterification, or a combination thereof.

In some embodiments, the interesterified fat or interesterified fat blend is produced by an enzymatic interesterification reaction which does not reach an equilibrium product distribution. It has been found that these embodiments provide a fat composition product with optimum properties for use in a seafood analogue composition, such as the properties discussed above.

Processes for the preparation of the fat compositions such as the interesterification reactions discussed above are known in the art, and are discussed in, for example, Dijkstra, A. J. Interesterification. In: The Lipids Handbook 3^{rd} Edition, pages 285-300 (F. D. Gunstone, J. L. Harwood, and A. J. Dijkstra (eds.), Taylor & Francis Group LLC, Boca Raton, FL) (2007).

Preferably, the fat composition comprises an interesterified fat blend comprising a vegetable oil high in stearic acid and a vegetable oil high in lauric acid. Preferably, the vegetable oil high in stearic acid is also high in monounsaturated fatty acids such as oleic acids. Accordingly, in typical embodiments, the fat composition comprises an interesterified fat blend comprising at least one fat selected from shea butter, shea stearin, shea olein, cocoa butter, cocoa stearin, cocoa olein, allanblackia fat, kokum fat, mango kernel fat, sal fat, illipe butter, and mixtures thereof; and at least one oil selected from coconut oil, coconut oil stearin, coconut oil olein, palm kernel oil, palm kernel olein, palm kernel stearin, babassu oil, and mixtures thereof.

In preferable embodiments, the fat composition comprises an interesterified blend of shea butter and coconut oil or an interesterified blend of shea stearin and coconut oil. For example, in some embodiments, the fat composition comprises an interesterified blend of from 20% to 80% by weight of shea butter and from 20% to 80% by weight of coconut oil. In other embodiments, the fat composition comprises an interesterified blend of from 20% to 80% by weight of shea stearin and from 20% to 80% by weight of coconut oil.

In highly preferable embodiments, the fat composition comprises a blend of (i) from 20% to 80% by weight of an interesterified blend of from 20% to 80% by weight of shea butter and/or shea stearin and from 20% to 80% by weight of coconut oil; and (ii) from 20% to 80% by weight of sunflower oil.

Preferably, the fat composition is present in the seafood analogue composition in an amount of from 1.5% to 20% by weight, preferably from 1.5% to 10% by weight and more preferably from 1.5% to 5% by weight, of the seafood analogue composition.

Preferably, the fat composition contains a substantially major portion of fat with very little water (i.e. the fat composition consists essentially of fat molecules). However, in some embodiments, the fat composition may contain water and be present in the form of an emulsion such as an oil-in-water emulsion or a water-in-oil emulsion, typically with a suitable emulsifier. In such embodiments, the weight percentage ranges provided above for the amount that the fat composition is present in the seafood analogue composition refers to only fat molecules present in the fat composition, and not any water present in the composition. Similarly, the weight percentages given above for the amount of water present in the seafood analogue composition refers to both water added in its own right during manufacture of the seafood analogue composition, and also to any water present in other components of the seafood analogue composition (such as water present in an emulsified fat composition), or water bound to any protein, as discussed in further detail below.

In one or more embodiments, the seafood analogue composition comprises from 35 to 65%, preferably from 40 to 60%, more preferably from 40 to 50% by weight of water.

Preferably, the seafood analogue composition comprises from 20% to 60% by weight of stabilizer blend of one or more starches and one or more polysaccharides; preferably from 30% to 50% of stabilizer blend of one or more starches and one or more polysaccharides; and more preferably from 40% to 50% of stabilizer blend of one or more starches and one or more polysaccharides. This is advantageous from sensory perspectives since the inventors have found that the above ranges of the stabilizer blend further improve the flavour release and the texture including the tenderness and the desired elasticity of seafood products.

In some embodiments, the one or more polysaccharides are selected from methylcellulose, hydroxypropyl methylcellulose, carboxymethyl cellulose, maltodextrin, carrageenan and salts thereof, alginic acid and salts thereof, agar, agarose, agaropectin, pectin and alginate, and a combination thereof. The polysaccharides may include modified polysaccharides, i.e. polysaccharides modified by any physical treatment, chemical treatment or chemical reaction.

In some embodiments, the seafood analogue composition comprises one or more gums, preferably selected from xanthan gum, guar gum, locust bean gum, gellan gum, gum arabic, vegetable gum, tara gum, tragacanth gum, konjac gum, fenugreek gum, and gum karaya, and a combination thereof.

Some of the polysaccharides and gums are hydrocolloids, i.e. substances which form a gel in the presence of water. The hydrocolloids are for example starch, xanthan gum, guar gum, locust bean gum, gum karaya, gum tragacanth, gum Arabic, celluloses, cellulose derivatives, carrageenan, and a combination thereof.

In some embodiments, the stabilizer blend of one or more starches and one or more polysaccharides comprises from 10 to 90% by weight of one or more polysaccharides; preferably from 20 to 80% by weight of one or more polysaccharides; more preferably from 30 to 60% by weight of one or more polysaccharides; advantageously from 40 to 50% by weight of one or more polysaccharides.

Preferably, the one or more starches are selected from non-modified starches, modified starches, or a combination thereof. More preferably, the one or more starches are selected from non-modified or modified vegetable starch, rice starch, tapioca starch, or a combination thereof. In one embodiment, the one or more starches are selected from modified starch derived from potatoes, pea starch, or a combination thereof. For example, the one or more starches are selected from potato starch, waxy maize starch, tapioca starch, pea starch or a combination thereof.

In some embodiments, the stabilizer blend of one or more starches and one or more polysaccharides comprises from 10 to 90% by weight of one or more starches; preferably from 20 to 80% by weight of one or more starches; more preferably from 30 to 60% by weight of one or more starches; and advantageously from 40 to 50% by weight of one or more starches.

In some embodiments, the seafood analogue composition comprises from 0 to 4.9% by weight of non-animal protein, preferably from 0 to 4.5% by weight of non-animal protein, more preferably from 0 to 2% by weight of non-animal protein or from 2 to 4.9% by weight of non-animal protein.

In some embodiments, the seafood composition of the invention comprises one or more non-animal proteins derived from fungi, plants, or a combination thereof.

Typically, the non-animal protein comprises plant protein. Preferably, the plant protein is selected from algae protein, black bean protein, canola wheat protein, chickpea protein, fava protein, lentil protein, lupin bean protein, mung bean protein, oat protein, pea protein, potato protein, rice protein, soy protein, sunflower seed protein, wheat protein, white bean protein, and protein isolates or concentrates thereof. In other embodiments, the non-animal protein comprises seitan, rice protein, mushroom protein, legume protein, tempeh, yam flour, tofu, mycoprotein, peanut flour, yuba, or a combination thereof.

More preferably, the non-animal protein comprises texturized vegetable proteins, preferably wherein the texturized vegetable proteins comprise texturized pea proteins, texturized fava proteins, texturized soy proteins, texturized wheat proteins or a combination thereof. Preferably, the texturized vegetable protein is present in the seafood analogue composition in an amount of from 10% to 20% by weight of the seafood analogue composition.

The non-animal protein may be present in the seafood analogue composition in an amount of from 5% to 30% by weight of the seafood analogue composition. More preferably, the non-animal protein is present in the seafood analogue composition in an amount of from 10% to 30% by weight of the seafood analogue composition, and more preferably from 15% to 30% by weight of the seafood analogue composition.

Plant protein is a source of protein which is obtained or derived from plants. The plant protein may be any suitable plant protein and may comprise a mixture of plant proteins and/or may include protein isolates or concentrates. Examples of suitable plant proteins include those discussed above. As discussed above, preferably, the plant protein comprises textured vegetable proteins (TVP). TVPs are extruded proteins, which may be either dry or moist (i.e. hydrated). TVP is widely available and may be made from plant sources as mentioned above, such as soy flour or concentrate. In dry form, TVP can comprise up to about 70 wt. % of protein, typically about 60 to 70 wt. % of protein, and when hydrated comprises typically about 10 to 20 wt. % of protein. Typically, when hydrated TVPs can contain up to 3 to 4 times their dry weight in water. As discussed above, the weight percentage ranges referred to above for water present in the seafood analogue compositions include both water added in its own right and water present in other components of the seafood analogue composition such as in textured vegetable proteins or emulsified with fat. Similarly, the weight percentage ranges given above for the amount of non-animal protein present in the seafood analogue composition refer to dry weight of protein, and do not include water bound to the non-animal protein such as in textured vegetable protein.

The plant protein used in the preparation of the seafood-analogue composition may be either dry (also referred to as ‘dry phase’ herein) or moist. Thus, in embodiments, the plant protein may be included in a dry mix of ingredients, which may include additional ingredients intended for inclusion in the seafood-analogue composition, such as carbohydrates, fiber and/or hydrocolloids, in addition to protein. If the plant protein is dry, it may be hydrated prior to and/or during the formation of the seafood-analogue composition. The term ‘dry’ used in relation to the plant protein and ‘dry phase’ used herein, is intended to mean that the phase comprising plant protein comprises less than 5 wt. % water, preferably less than 2 wt. % water, more preferably less than 1 wt. % water, even more preferably that it is substantially free from water. In other preferred embodiments, the a, of the dry phase is 0.90 or lower, more preferably below 0.80. The dry phase comprising plant protein is typically provided in a substantially dehydrated state to reduce microbial growth as far as possible so as to extend shelf life.

The seafood-analogue composition comprises water, which may be added as a separate component to the composition or derive from other components of the composition as discussed above. The amount of water is not particularly limited and, as the skilled person will appreciate, will vary depending on the intended consistency of the seafood-analogue composition. Reference to ‘water’ herein is intended to include drinking water, demineralized water or distilled water, unless specifically indicated. Preferably, the water employed in connection with the present invention is demineralised or distilled water. As the skilled person will appreciate, deionized water is also a sub-class of demineralized water.

The seafood analogue composition typically comprises one or more additional ingredients. Whilst these one or more additional ingredients may be preferable to include in the seafood analogue compositions, it will be understood that the inclusion of the one or more additional ingredients is not essential.

The seafood analogue composition may comprise one or more flavouring additives. Preferably, the one or more flavouring additives are present in an amount of from 0.5% to 2% by weight of the seafood analogue composition. Suitable flavouring additives known in the art may be used in the seafood analogue compositions.

The seafood analogue composition may comprise one or more colouring additives. Typically, the one or more colouring additives are present in an amount of from 0.5% to 5% by weight of the seafood analogue composition. Suitable colouring additives known in the art may be used in the seafood analogue compositions.

Examples of other additives that may be included in the seafood analogue compositions include an ionic or non-ionic emulsifier, a polyhydroxy compound, milk, liquid flavours, alcohols, humectants, honey, liquid preservatives, liquid sweeteners, liquid oxidising agents, liquid reducing agents, liquid anti-oxidants, liquid acidity regulators, liquid enzymes, milk powder, hydrolysed protein isolates (peptides), amino acids, yeast, sugar substitutes, salt, spices, fibre, flavour components, colourants, thickening and gelling agents, egg powder, enzymes, gluten, vitamins, preservatives, sweeteners, oxidising agents, reducing agents, anti-oxidants, acidity regulators, or combinations thereof.

Amino acids are a preferred additive for the seafood-analogue compositions of the invention, since these are known to contribute to the Maillard reaction, a form of non-enzymatic browning resulting from the chemical reaction between amino acids and sugars upon heating. This is used in flavour development of cooked foods and this reaction can be used in the seafood-analogue composition to replicate the taste of seafood by creating savoury seafoody flavours.

In preferable embodiments, the seafood analogue is suitable for consumption by vegetarians and vegans. Accordingly, in preferable embodiments, the seafood analogue composition is substantially free of animal protein, and more preferably, the seafood analogue composition is free of animal protein.

In preferable embodiments, the seafood analogue composition is substantially free of protein, and more preferably, the seafood analogue composition is free of protein. This embodiment is particularly well suited for certain seafood analogue food products. Indeed, it is believed that the stabilizer blend has not only the role of stabilizing the seafood analogue composition, but also provides the desired texture to the seafood analogue composition.

In preferable embodiments, the seafood analogue composition is substantially free of animal-derived products, and more preferably, the seafood analogue composition is free of animal-derived products.

However, in some embodiments, the seafood analogue compositions may comprise animal-derived products such as animal derived proteins or fats. Accordingly, in some embodiments, the seafood analogue composition further comprises one or more animal-derived products such as animal oils, marine oils, animal-derived proteins, animal-derived polysaccharides, or any combination thereof. In some embodiments, the one or more animal-derived products comprise animal milk proteins, animal milk fats, or a combination thereof. In these embodiments, the seafood analogue compositions may be suitable for consumption by vegetarians on the basis that they comprise non-animal protein and proteins or fats derived from animal milk. These seafood analogue compositions are suitable for consumption by vegetarians since they do not include fats or proteins derived from seafood. However, it will of course be understood that such seafood analogue compositions are not suitable for consumption by vegans.

In embodiments where the seafood analogue compositions comprise one or more animal-derived products, the one or more animal-derived products are typically present in the seafood analogue composition in an amount of from 1% to 20% by weight of the seafood analogue composition.

According to a second aspect of the invention, there is provided a food product comprising a seafood analogue composition of the invention. The food product may be an uncooked food product, a cooked food product, or a partially cooked food product.

Typically, the food product is a vegetarian or vegan seafood substitute food product. Preferably, the vegetarian or vegan seafood substitute food product is a calamari analogue product; crustacean product such as a prawn analogue product, a lobster analogue product, a crab analogue product, a crabstick analogue product, a scampi analogue product; or a fish analogue product such as a fish cake or a fish filet. According to a third aspect of the invention, there is provided the use of a fat composition in a seafood analogue composition, wherein the fat composition comprises from 20% to 85% by weight of saturated fatty acids; from 10% to 50% by weight of stearic acid (C18:0); and from 2% to 35% by weight of lauric acid (C12:0).

Preferably, the use further comprises using the seafood analogue composition in a food product.

Preferably, the seafood analogue composition, fat composition and/or food product are as described above.

The use may comprise using the fat composition to provide improved release of flavours from the seafood analogue composition when cooked and consumed when compared to an analogous seafood analogue composition comprising the same amount by weight of rapeseed oil. Without being limited by theory, the improved release of flavours compared to rapeseed oil is believed to be due to the fat compositions having a higher solid fat content than coconut oil at mouth temperatures of from 30° C. to 35° C. Many flavours and flavouring additive compounds are fat soluble and so are dissolved within the fat of the seafood analogue composition. With a higher solid fat content, the release of the dissolved flavours from the fat is delayed over a longer period of time. The delayed release of flavours is believed to enable the seafood analogue composition to more closely resemble the mouth feel and delayed flavour release of seafood, which contains higher melting point fats which typically have higher solid fat contents at mouth temperature. A further resulting benefit is that less fat is required, which results in a number of further advantages as described herein.

The use may comprise using the fat composition to provide improved texture of the seafood analogue composition when cooked when compared to an analogous seafood analogue composition comprising the same amount by weight of rapeseed oil. Without being limited by theory, the use may comprise using the fat composition to provide an increased resemblance to real seafood of a surface of a cooked food product comprising the seafood analogue composition when compared to an analogous food product comprising an analogous seafood analogue composition comprising the same amount by weight of rapeseed oil. As discussed above, a disadvantage of rapeseed oil is that the liquid nature of this oil leads to a non-structured seafood analogue composition resulting in oily seafood doughs which create problems during processing of the seafood analogue compositions. By contrast, in certain seafood analogue compositions of the invention, plasticized fat structures are provided, which more closely mimics the appearance of seafood fat in certain seafood. Alternatively, the seafood analogue composition has a more homogenous structure, which mimic the visual appearance of real seafood. The fat compositions described herein can be effectively processed and mixed with the other ingredients of the seafood analogue composition during manufacture without melting. This results in a substantially uniform dispersion of the fat composition in the seafood analogue compositions. The surfaces of food products made from the seafood analogue compositions thus more closely resemble the visual appearance of seafood.

The use may comprise using the fat composition to improve the nutritional profile of the seafood analogue composition when compared to an analogous seafood analogue composition comprising the same amount by weight of coconut oil. The term analogous seafood analogue composition as used herein is used to refer to an equivalent weight of a seafood analogue composition that is identical to the seafood composition of the invention, with the exception of the nature of the fat present therein. The analogous seafood analogue composition contains the same amount by weight of coconut oil as the seafood analogue composition of the invention contains the fat composition. The nutritional profile of the seafood analogue composition of the invention may be improved in comparison to coconut oil since it contains a lower total amount of saturated fatty acid residues per unit weight than coconut oil. Coconut oil contains around 90% saturated fatty acid residues. Without being limited by theory, it is believed that fats with higher saturated fatty acid contents increase the risk of heart disease, high blood pressure and associated conditions, and also have a detrimental effect upon the cholesterol levels of consumers. Accordingly, in some embodiments, the use comprises using the fat composition to improve the effect on in vivo cholesterol levels in a consumer of the seafood analogue composition when compared to an analogous seafood analogue composition comprising the same amount by weight of coconut oil, although it will be appreciated that other health and wellbeing benefits may also be realised by the use of the fat compositions in seafood analogue compositions in place of coconut oil and similar fats.

According to a fourth aspect of the invention, there is provided a process of manufacturing a seafood analogue composition of the invention or a food product of the invention.

Preferably, there is provided a process of manufacturing a seafood analogue composition of the invention, or a food product of the invention, wherein the process comprises:
(a) providing a mixture of water and a stabilizer blend of one or more starches and one or more polysaccharides;
(b) combining the mixture from step (a) with the fat composition and optionally one or more additional components to form the seafood analogue composition; and
(c) optionally forming the seafood analogue composition into food products.

In one or more embodiments, the forming step C) is performed by cutting, moulding, pressing, rolling, grinding, dicing, marination, or any combination thereof.

Preferably, the process further comprises cooking the food product to form a cooked food product or partially cooked food product.

Whilst the above-described steps are preferable steps for manufacturing the seafood analogue compositions or food products described herein, it will be appreciated that other suitable processes may also be used to manufacture the seafood analogue compositions and food products.

Any suitable method may be used to shape the seafood-analogue composition into the desired shape. In embodiments, this may be performed by cutting, moulding, pressing, extrusion, rolling, grinding or any combination thereof. These processes may be performed using an apparatus, which may be operated manually or may be automated. In embodiments, the seafood-analogue composition may be compressed for 5 minutes to 24 hours, preferably 1 hour to 12 hours, more preferably 3 hours to 8 hours. The duration and pressure of compression is determined by the desired properties of the resulting food product, such as its size and density, taking into account the properties of the seafood-analogue composition, such as adhesiveness, among other factors. This may form the desired shape of the food product, or it may be further processed such as by pelletizing, grinding or cutting, for instance to replicate the attributes of ground/minced.

The process of preparing a seafood-analogue composition may further comprise cooking or part-cooking the composition, which may have been formed into a food product. Cooking may comprise boiling, baking, steaming, frying and/or microwaving. In preferred embodiments, cooking is at sufficient temperature such that the Maillard reaction may occur (for example, above 80° C. and up to 180° C., preferably from 130° C. to 170° C.). The Maillard reaction is useful for desirable browning of the food product.

Aspects of the present invention will now be described by way of example and with reference to the following figures in which:

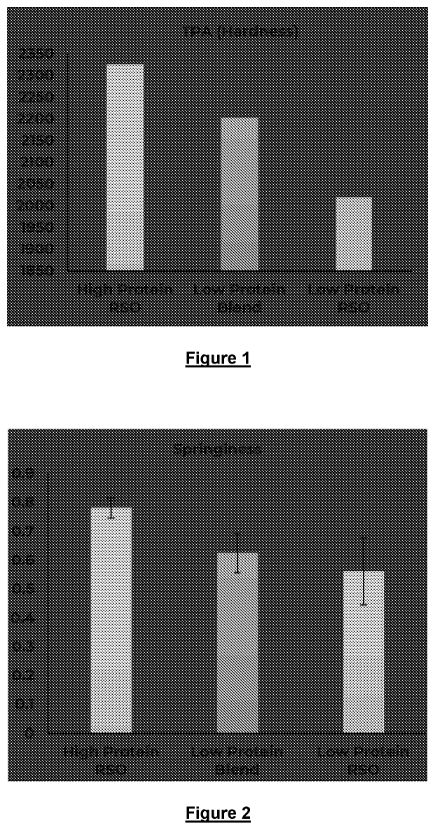

FIG. 1 shows the results of shrimp analogues produced in accordance with the examples and measured for hardness;

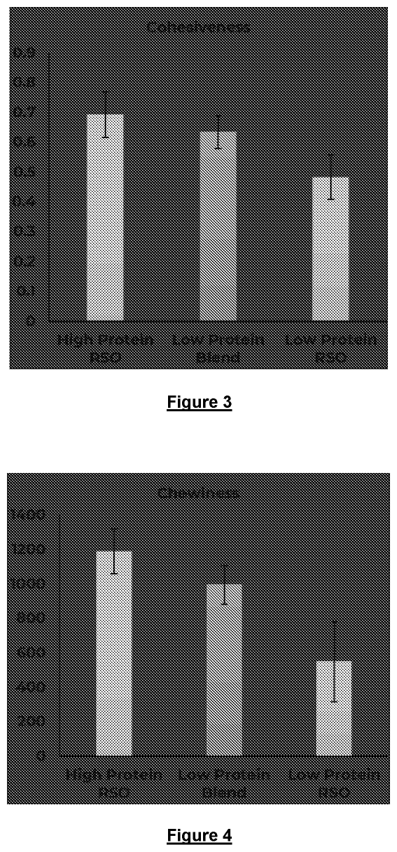

FIG. 2 shows the results of shrimp analogues produced in accordance with the examples and measured for springiness;

FIG. 3 shows the results of shrimp analogues produced in accordance with the examples and measured for cohesiveness;

FIG. 4 shows the results of shrimp analogues produced in accordance with the examples and measured for chewiness; and

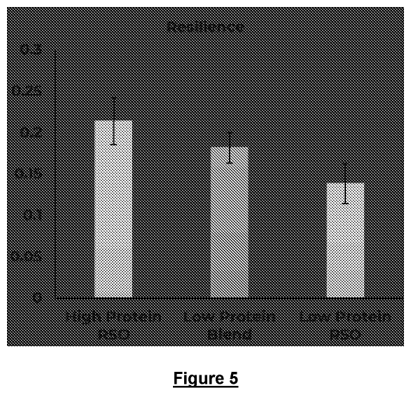

FIG. 5 shows the results of shrimp analogues produced in accordance with the examples and measured for resilience.

### EXAMPLES

A series of shrimp analogues were produced by mixing components in accordance with the following recipes.

| | Recipe | | |
|---|---|---|---|
| | Low Protein | High Protein | Low Protein |
| | Blend | RSO | RSO |
| Ingredient | % | % | % |
| Textured veg protein | 2 | 6 | 2 |
| Isolated soy protein | 1.5 | 5 | 1.5 |
| Gluten | 1.3 | 4 | 1.3 |
| Rapeseed oil | 0 | 15 | 15 |
| Interesterified blend of | 15 | 0 | 0 |
| 70% shea butter + 30% | | | |
| coconut fat | | | |
| Cold water | 5 | 15 | 5 |
| Ice-water | 56.3 | 41.6 | 56.3 |
| Starch (Pregeflo) | 6 | 2 | 6 |
| Modified tapioca starch | 2 | 1.5 | 2 |
| (Nat Frigex HV) | | | |
| Methylcellulose (Tylopur) | 3.2 | 3.2 | 3.2 |
| Iota carrageenan | 1.5 | 1.5 | 1.5 |
| (Genuvisco MB11F) | | | |
| Bamboo fiber, 400X | 3 | 2 | 3 |
| Yeast extract | 1 | 1 | 1 |
| (Biospringer, the lighter | | | |
| coloured one) | | | |
| Shrimp flavour | 1 | 1 | 1 |
| Salt | 0.7 | 0.7 | 0.7 |
| Garlic powder | 0.5 | 0.5 | 0.5 |

The shrimp analogues were cooked as follows:

High-Protein Recipe Cooking* *The cooking process for the high-protein samples is due to a thick skin forming when fried at 140° C. for 10 minutes (resulting in a mushy colder center), whilst frying at 120° C. for 10 minutes resulted in an unfinished product—thus the cooking was adjusted to enable a fair comparison of the final products.
Fried at 120° C. for 5:30 minutes and then at 140° C. for 2:30 minutes.
   Low-Protein Recipe Cooking\hat{ }\hat{ } The cooking process for the low-protein samples is longer as a reduction in the amount of protein resulted in an increased cooking time in order to produce a cooked product and to allow a fair comparison of the final products.
Fried at 120° C. for 5:30 minutes and then at 140° C. for 10 minutes.

The final products were then tested for hardness, springiness, cohesiveness, chewiness, and resilience by means of the following test methods:

### Measuring Methods

The samples were tested using the following materials:
Texture analyser—TA.XT Plus (Stable Micro Systems)
Probe—P/50 17161 (50 mm cyl. aluminium)
Load cell—50 Kg
Exponent software (connected to equipment)
Samples are from whole shrimp “after frying”

The texture analyser was set to the following methodology:
2-cycled measurement imitating a biting motion
Macro calculates hardness, cohesiveness, springiness, resilience, adhesiveness

The texture analyser was set to the following:
Pre-test speed: 2 mm/s
Test speed: 3 mm/s
Post test speed: 5 mm/s
Compression depth: 4 mm
Time between cycles: 2 s
Trigger type: automatic on 5 g
Data acquisition rate: 200 pps

### Results

As demonstrated by the results of FIG. 1, the use of a fat composition in accordance with the present invention in a low protein composition allowed the production of a shrimp analogue mimicking that of a high-protein recipe produced from rapeseed oil. To ensure that the results were not inherent to the recipe itself, the same low-protein recipe was used to produce a rapeseed oil containing shrimp analogue. As can be seen from the results shown in FIG. 1, this resulted in a significant loss in hardness making such a composition unsuitable for forming a low-protein shrimp analogue.

Similarly, as shown in FIG. 2, the use of a fat composition in accordance with the present invention in a low-protein composition allowed the production of a shrimp analogue close to that of a high-protein recipe produced from rapeseed oil in terms of springiness. Once again, to ensure that the results were not inherent to the recipe itself, the same low-protein recipe was used to produce a rapeseed oil containing shrimp analogue. As can be seen from the results shown in FIG. 2, this resulted in an unacceptable loss in springiness as a result of which such a composition is unsuitable for forming a low-protein shrimp analogue which would be desired by consumers.

FIG. 3 shows the results of the tests relating to cohesiveness, and once again the benefits of using a fat composition in accordance with the present invention in a low-protein composition to produce a shrimp analogue mimicking that of a high-protein recipe produced from rapeseed oil. The use of such a fat allows for a good level of cohesiveness, which is immediately lost when, for example, rapeseed oil is used in a low-protein composition. Such loss of cohesiveness would again be unacceptable to a consumer in terms of desired organoleptic properties.

The benefits of the use of a fat composition in accordance with the present invention are even more starkly noticeable with respect to chewiness and thus the inherent mouthfeel in eating a meat analogue. As shown in FIG. 4, the low-protein composition in accordance with the present invention is comparable to that of a high-protein sample, whereas the use of rapeseed oil results in a shrimp analogue which suffers from severely reduced chewiness, which prevents the analogue from mimicking seafood.

Finally, FIG. 5 once again demonstrates the benefits of the use of a fat composition in accordance with the present invention in producing a low-protein seafood analogue.

Thus, the results clearly demonstrate the ability to produce a low-protein seafood analogue without suffering a significant reduction in the properties required to meet consumer demand, whilst at the same time allowing for a reduction in saturated fatty acid levels.

1. A seafood analogue composition comprising from 1% to 20% by weight of a fat composition; from 10% to 60% by weight of a stabilizer blend of one or more starches and one or more polysaccharides; less than 5% by weight of non-animal protein; and from 30% to 70% by weight of water; wherein the fat composition comprises from 20% to 85% by weight of saturated fatty acid residues; from 10% to 50% by weight of stearic acid residues (C18:0); and from 2% to 35% by weight of lauric acid residues (C12:0); wherein said percentages of fatty acid residues refers to fatty acids bound as acyl groups in glycerides in the fat composition and being based on the total weight of C4 to C24 fatty acid residues bound as acyl groups present in the fat composition.

2. The seafood analogue composition according to claim 1, wherein the fat composition comprises from 20% to 70% by weight of saturated fatty acids.

3. The seafood analogue composition according to claim 1, wherein the fat composition comprises less than 10% by weight of palm oil.

4. The seafood analogue composition according to claim 1, wherein the fat composition is a non-hydrogenated fat composition.

5. The seafood analogue composition according to claim 1, wherein the fat composition comprises 20% by weight or less of palmitic acid (C16:0).

6. The seafood analogue composition according to claim 1, wherein the fat composition has a weight ratio of stearic acid (C18:0) to palmitic acid (C16:0) of from 1:1 to 12:1.

7. The seafood analogue composition according to claim 1, wherein the fat composition has a weight ratio of lauric acid (C12:0) to stearic acid (C18:0) of from 1:4 to 4:1.

8. The seafood analogue composition according to claim 1, wherein the fat composition comprises from 10% to 25% by weight lauric acid (C12:0); and/or from 15% to 45% by weight stearic acid (C18:0).

9. The seafood analogue composition according to claim 1, wherein:
(i) the fat composition has a solid fat content (SFC) N40 of less than 10, measured on unstabilised fat according to ISO 8292-1;
(ii) the fat composition has a solid fat content (SFC) N20 of from 35 to 60, as measured on the unstabilised fat according to ISO 8292-1; and/or
(iii) the fat composition has a solid fat content (SFC) N30 of from 5 to 35, as measured on the unstabilised fat according to ISO 8292-1.

10. The seafood analogue composition according to claim 1, wherein the fat composition comprises an interesterified fat.

11-12. (canceled)

13. The seafood analogue composition according to claim 1, wherein the fat composition comprises an interesterified fat blend comprising at least one fat selected from shea butter, shea stearin, shea olein, cocoa butter, cocoa stearin, cocoa olein, allanblackia fat, kokum fat, mango kernel fat, sal fat, illipe butter, and mixtures thereof; and at least one oil selected from coconut oil, coconut oil stearin, coconut oil olein, palm kernel oil, palm kernel olein, palm kernel stearin, babassu oil, and mixtures thereof.

14. The seafood analogue composition according to claim 1, wherein the fat composition comprises an interesterified blend of shea butter and coconut oil or an interesterified blend of shea stearin and coconut oil.

15. The seafood analogue composition according to claim 1, wherein the fat composition comprises an interesterified blend of from 20% to 80% by weight of shea butter and from 20% to 80% by weight of coconut oil.

16. The seafood analogue composition according to claim 1, wherein the fat composition comprises an interesterified blend of from 20% to 80% by weight of shea stearin and from 20% to 80% by weight of coconut oil.

17. The seafood analogue composition according to claim 1, wherein the fat composition comprises a blend of (i) from 20% to 80% by weight of an interesterified blend of from 20% to 80% by weight of shea butter and/or shea stearin and from 20% to 80% by weight of coconut oil; and (ii) from 20% to 80% by weight of sunflower oil.

18. The seafood analogue composition according to claim 1, wherein the fat composition comprises from 5 to 35% by weight of CN46 and CN48 triglycerides.

19. The seafood analogue composition according to claim 1, wherein the fat composition comprises from 2 to 12% by weight of St2M triglycerides.

20. The seafood analogue composition according to claim 1, wherein the seafood analogue composition comprises from 35 to 65% by weight of water.

21. The seafood analogue composition according to claim 1, wherein the seafood analogue composition comprises from 20% to 60% by weight of stabilizer blend of one or more starches and one or more polysaccharides.

22. The seafood analogue composition according to claim 1, wherein the polysaccharides are selected from methylcellulose, hydroxypropyl methylcellulose, carboxymethyl cellulose, maltodextrin, carrageenan and salts thereof, alginic acid and salts thereof, agar, agarose, agaropectin, pectin and alginate, and a combination thereof.

23. The seafood analogue composition according to claim 1, wherein the seafood analogue composition comprises one or more gums.

24. The seafood analogue composition according to claim 1, wherein the stabilizer blend of one or more starches and one or more polysaccharides comprises from 10 to 90% by weight of one or more polysaccharides.

25. The seafood analogue composition according to claim 1, wherein the one or more starches are selected from non-modified starches, modified starches, or a combination thereof.

26. The seafood analogue composition according to claim 1, wherein the stabilizer blend of one or more starches and one or more polysaccharides comprises from 10 to 90% by weight of one or more starches.

27. The seafood analogue composition according to claim 1, wherein the seafood analogue composition comprises from 0 to 4.9% by weight of nonanimal protein.

28. The seafood analogue composition according to claim 1, wherein the non-animal protein comprises protein derived from fungi, plants, or a combination thereof.

29-35. (canceled)

36. The seafood analogue composition according to claim 1, wherein the fat composition is present in the seafood analogue composition in an amount of from 1.5% to 15% by weight of the seafood analogue composition.

37. The seafood analogue composition according to claim 1, wherein the fat composition is present in the seafood analogue composition in an amount of from 1.5% to 10% by weight of the seafood analogue composition.

38. The seafood analogue composition according to claim 1, wherein the fat composition is present in the seafood analogue composition in an amount of from 1.5% to 5% by weight of the seafood analogue composition.

39. The seafood analogue composition according to claim 1, wherein the seafood analogue composition is substantially free of animal protein.

40. The seafood analogue composition according to claim 1, wherein the seafood analogue composition is substantially free of protein.

41. The seafood analogue composition according to claim 1, wherein the seafood analogue composition is substantially free of animal-derived products.

42. The seafood analogue composition according to claim 1, wherein the seafood analogue composition further comprises one or more animal-derived products.

43. The seafood analogue composition according to claim 41, wherein the one or more animal-derived products comprise animal milk proteins, animal milk fats, or a combination thereof.

44. A food product comprising a seafood analogue composition according to claim 1.

45-54. (canceled)

55. A process of manufacturing a seafood analogue composition according to claim 1, wherein the process comprises:
(a) providing a mixture of water and a stabilizer blend of one or more starches and one or more polysaccharides;
(b) combining the mixture from step (a) with the fat composition and optionally one or more additional components to form the seafood analogue composition; and
(c) optionally forming the seafood analogue composition into food products.

56-57. (canceled)
